(19) United States
(12) Patent Application Publication
(10) Pub. No.: US 2005/0266787 A1
(43) Pub. Date: Dec. 1, 2005

(54) Token collector and dispenser

(76) Inventor: Kay Broaddus, Dunwoody, GA (US)

Correspondence Address: Marvin H. Kleinberg, Suite 1080, 2049 Century Park East, Los Angeles, CA, 90067, US

(21) Appl. No.: 10/852,800

(22) Filed: May 25, 2004

(51) Int. Cl. G07D 1/00; G07F 7/00

(52) U.S. Cl. 453/57

(57) ABSTRACT

A universal token dispenser and collector is alternatively connected to a revenue receiving device to dispense tokens upon receipt of revenue and to a fulfillment device to deliver quantities of a desired commodity upon receipt of tokens. The dispenser and collector remains with the fulfillment device until full of tokens and with the revenue receiving device until empty of tokens.

### BACKGROUND OF THE INVENTION

1. Field of the Invention

The present invention relates to vending machines and, more particularly, a token collector and dispenser which enables the rapid recycling of tokens in a device which dispenses tokens upon payment at a first station and, when empty, receives tokens to dispense goods at a second station.

2. Description of the Related Art

It has been well known to provide vending systems wherein at one station, tokens or other media are dispensed after receipt of payment, whether by currency or credit/debit cards and, at another station, the tokens or other media are redeemed for goods or services. Typical of such systems is the fare collection system in use in rapid transit systems across the country. In exchange for currency or a debit/credit card payment, one or more tokens or cards are dispensed which can be used to operate gates or turnstiles which provide access to trains.

In other applications, tokens, rather than coins or currency are redeemed for goods and services. The tokens can be provided by a cashier or can be dispensed from a machine. In one specialized application, a golf driving range dispenses golf balls for tokens. The tokens are purchased at a cashier's station and, at a remote station near the driving range, a machine dispenses golf balls when a token is received.

A problem frequently arises from the lack of controls on the dispensing of tokens and a need for better accountability. Aside from the need in such systems for separate and often different dispensing and vending mechanisms, there is a need to control the integrity of the process.

### SUMMARY OF THE INVENTION

According to the present invention, there is provided a universal token receptacle which can be installed either at the vending location or at the fulfillment location. If at the vending location, the receptacle, upon receipt of signals from apparatus which receives currency, coins or debit or credit instruments, orders the receptacle to dispense a number of tokens corresponding to the received payment. When the receptacle has dispensed all of the tokens stored therein, the empty receptacle is removed and replaced with a similar receptacle that contains a full complement of tokens.

The empty receptacle is taken to a point of fulfillment where it is connected to a dispensing mechanism that provides a premeasured quantity of a commodity, here golf balls, upon the receipt of a token. The receptacle includes a token receiver which signals the dispenser to release a predetermined number of golf balls for each token. When the receptacle becomes filled with tokens, it is removed and replaced with an empty receptacle from the vending location and the full receptacle is taken to the vending location.

Depending upon the number of tokens that are to be in circulation at any time, as few as two receptacles may be adequate for an operation. It would seem, however, that to avoid delays in operation, a pair of spare receptacles, one full of tokens is made available as a back up at the vending station and one empty receptacle is made available at the fulfillment station. A full receptacle can be quickly replaced by an empty one at the fulfillment station and an empty receptacle can be quickly replaced by a full one at the vending station.

Accordingly, it is an object of the invention to provide a universal receptacle that can either dispense tokens at a vending station on the receipt of an appropriate signal when not empty or receive tokens and signal for the distribution of a commodity, i.e. golf balls at a fulfillment station when not full. Full and empty receptacles are then transferred to the station where they will be needed.

It is another object of invention to have a universal receptacle which can either dispense tokens when signaled so to do, or, upon receipt of tokens, to signal and enable the dispensing of goods or services.

The novel features which are characteristic of the invention, both as to structure and method of operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

FIG. 1 is a perspective view of a prior art golf ball dispenser;

FIG. 2 is a perspective view of a token collector/dispenser of the present invention at a vending location;

FIG. 3 is a perspective view of a golf ball dispenser with a token collector/dispenser at a fulfilment location;

FIG. 4 is a side phantom view of a token collector/dispenser according to the present invention;

FIG. 5 is a perspective view of an open token collector/dispenser according to the present invention;

FIG. 6 is a perspective view of a collector/dispenser partially installed at the vending location; and

FIG. 7 is a perspective view of a collector/dispenser partially installed at the fulfilment location.

### DESCRIPTION OF THE PREFERRED EMBODIMENTS

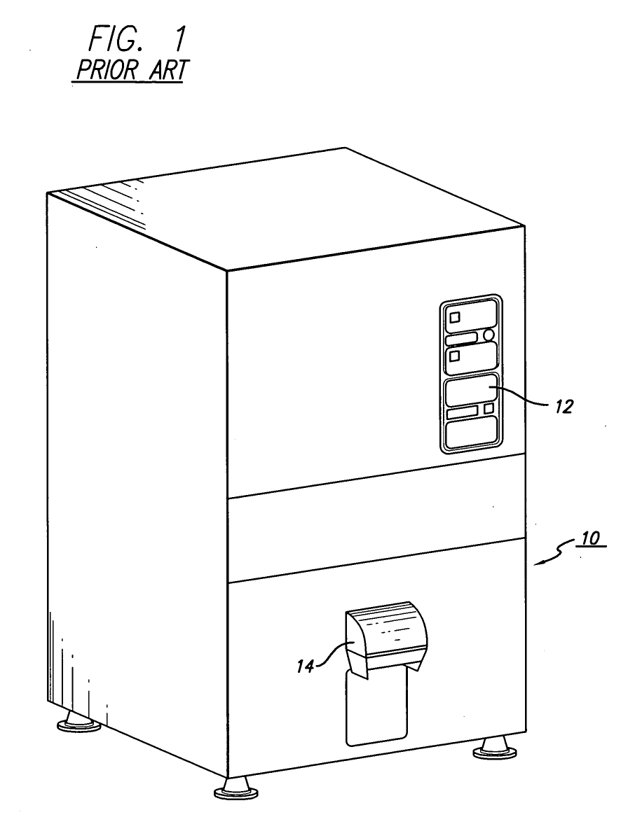

Turning first to FIG. 1, there is shown a prior art golf ball dispenser 10 which is equipped with a conventional vending machine coin and/or bill acceptor mechanism 12. When the appropriate value of coins and/or bills are inserted into the acceptor mechanism 12, an electronic signal will be sent to a golf ball delivery apparatus and a predetermined number of golf balls will be delivered to the patron at a dispensing cup 14.

In many venues, it is desirable, for fiscal controls, to use tokens in lieu of money to actuate the ball delivery mechanism and, in prior art systems, the tokens can be purchased at one or more vending locations where the transaction may be recorded.

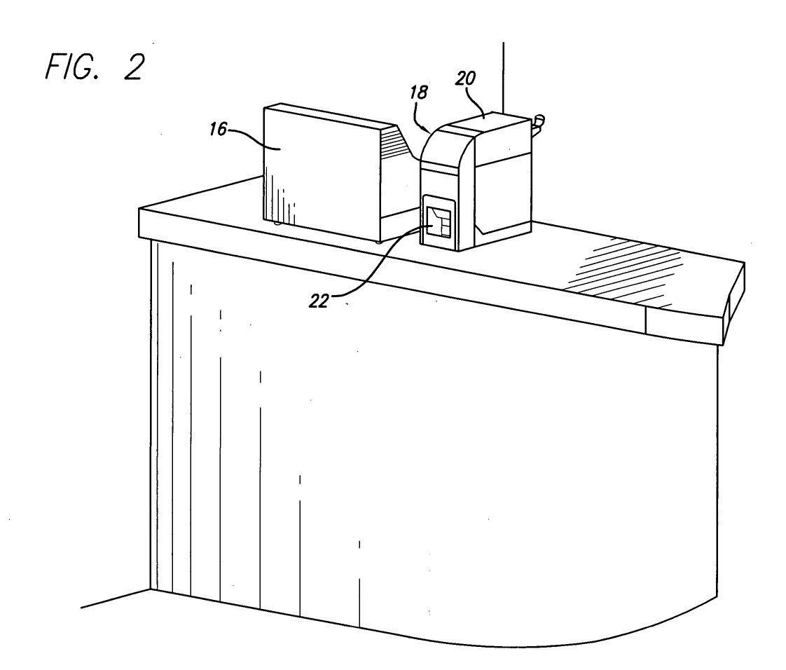

In FIG. 2, a conventional cash register 16 is shown at a vending location. A cash register 16 is electronically connected to a token collector/dispenser station 18 in which a collector/dispenser 20 according to the present invention is installed. The register 16 operator can provide an electrical signal to the station 18 to dispense tokens in exchange for monetary consideration, whether by cash or debit/credit card. The system of the present invention therefore imposes the fiscal control of the associated cash register 16 upon the transaction in that tokens can only be obtained through the collector/dispenser 20.

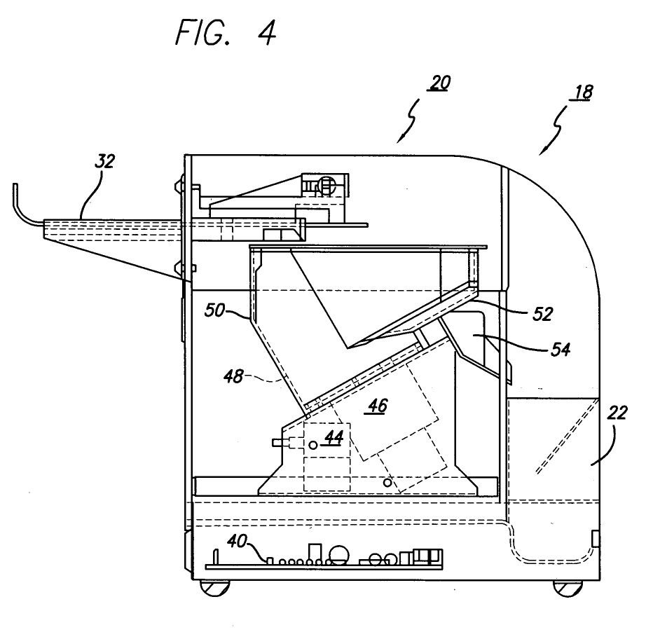

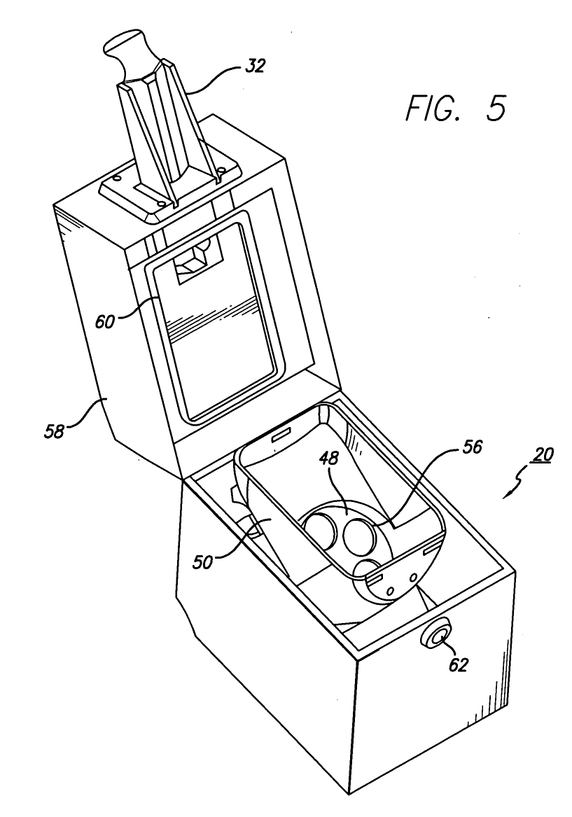

Upon receipt of an appropriate signal to the station 18, a token delivery mechanism within the collector/dispenser 20 transfers tokens from a hopper to a delivery chute 22. The operation of the collector/dispenser 20 will be discussed in greater detail in conjunction with FIGS. 4 and 5, below.

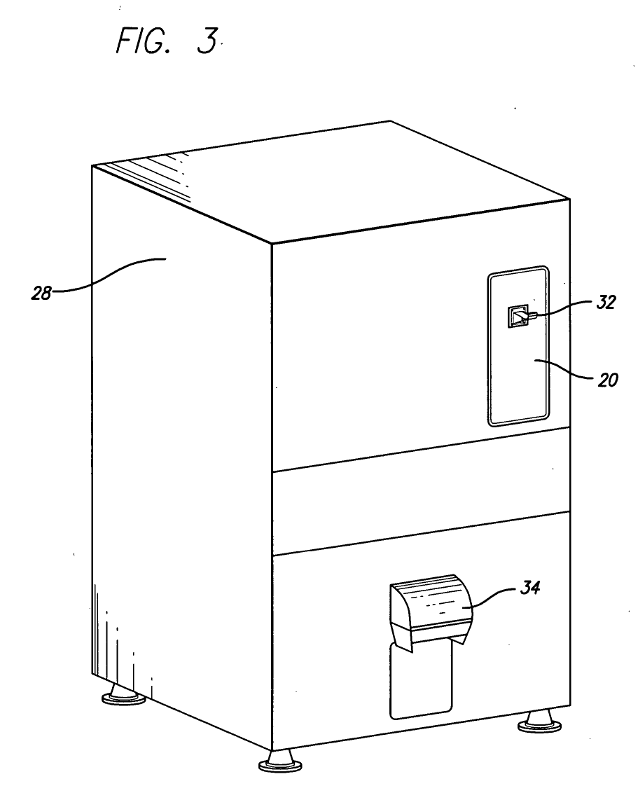

In FIG. 3, there shown a golf ball delivery mechanism 28 at a fulfilment station location. A collector/dispenser 20 is installed in the delivery mechanism 28 and includes a token receiving mechanism 32 which accepts tokens and signals the receipt of a token. An activating signal is then provided to the ball delivery mechanism 28 which delivers a predetermined number of golf balls through a dispensing cup 34. The operation of the ball delivery mechanism may also be completely mechanical, triggered by the token receiving mechanism 32.

As can be seen, the same basic collector/dispenser device receives tokens at the fulfilment location and dispenses tokens at the vending location. Turning to FIGS. 4 and 5, there is shown side and perspective views, respectively, of the operating components of the collector/dispenser 20 when docked in the station 18 of FIG. 2. A control circuit board 40 provides signals for the operation of a token delivery mechanism 42 which can be an off-the-shelf item available from the Money Controls division of Coin-CO, located in St. Louis, Mo.

The mechanism 42 includes a motor 44, a gear box 46 and an apertured wheel 48 which rotates through a token hopper 50. Each of the apertures 56 (best seen in FIG. 5) in the wheel 48 is the size of a token and, as the wheel 48 rotates, tokens drop into the apertures 56 and are carried to the dispensing portal 52 where ejector elements (not shown) transfer the tokens to an exit chute 54 which empties into the delivery chute 22 where a patron can retrieve the tokens that have been purchased.

The operating mechanism is better shown in FIG. 5 which is a perspective view of the open collector/dispenser 20. Here, one can see the wheel 48 and the token sized apertures 56 in the wheel 48. A hinged upper portion 58 permits access to the interior and more, particularly, the token hopper 50. A gasket 60 seals the upper portion 58 and a lock 62 is provided to secure the contents.

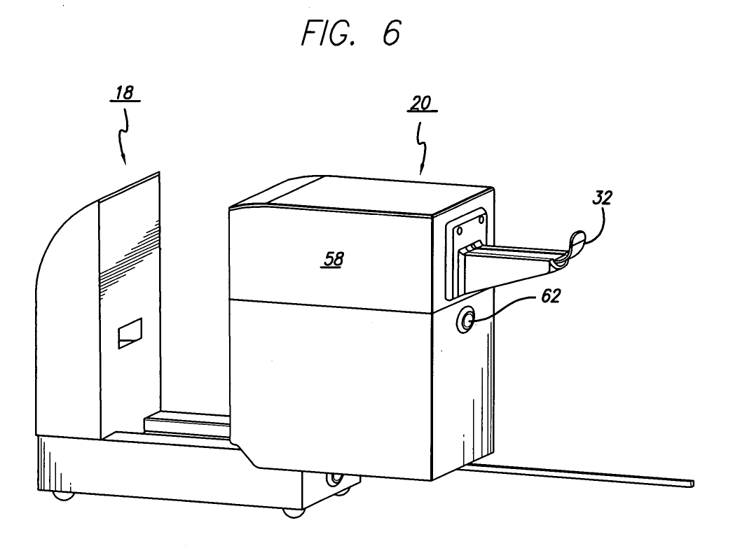

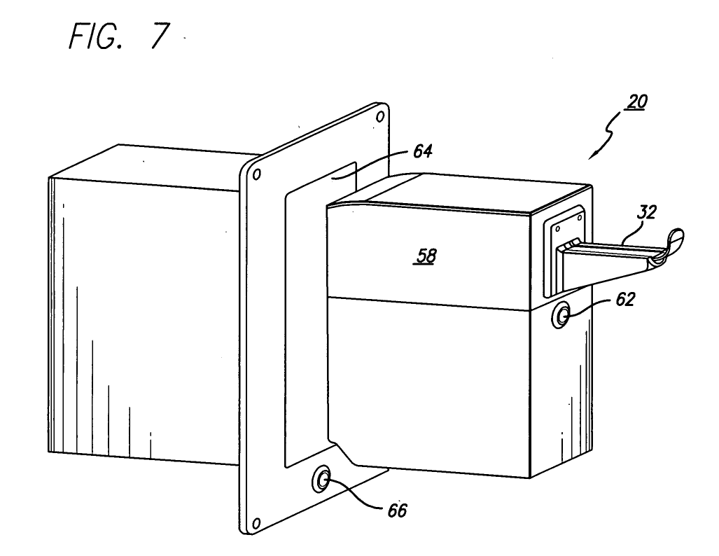

In FIGS. 6 and 7, the collector/dispenser 20 is shown being installed at the vending location and the fulfilment location, respectively. For the vending location, the station 18 is equipped with the necessary electrical connectors to supply power and signals to the circuits of the collector/dispenser 20.

Similarly, at the fulfillment location where golf balls are delivered, a receptacle 64 is provided with electrical connections to a source of power and to the ball dispensing machinery. The receptacle 64 also includes a security lock 66 which engages cooperating elements in the collector/dispenser 20 to retain the collector/dispenser 20 safely in place. When unlocked, the collector/dispenser 20 can be easily removed from the ball delivery mechanism 28 and returned to the vending location to dispense the tokens collected at the fulfilment station.

Those skilled in the art will readily find other applications for the collector/dispenser concept of the present invention in vending and fulfilment environments where tight fiscal controls are desired.

Thus, there has been described, in detail, a novel, universal token collector/dispenser which can be moved between a token dispensing station and a fulfillment station which receives tokens and provides commodities, in the environment of a golf ball dispensing operation in which tokens are purchased and are redeemed for golf balls. The scope of the invention should be limited only by the claims set forth below.

1. A universal token collector and dispenser comprising:
a hopper for storing tokens;
token dispensing means coupled to said hopper and operable in response to the receipt of value, for dispensing a number of tokens related to the magnitude of the value received;
token collecting means connected to said hopper and operable, in response to receipt of a token, for distributing a predetermined quantity of a commodity for each token received,
whereby the token collector and dispenser alternatively receives tokens to control the distribution of a commodity and in response to the receipt of value, dispenses tokens.

2. The universal token collector and dispenser of claim 1, wherein said token dispensing means is is responsive to signals corresponding to and representative of the magnitude of value received.

3. The universal token collector and dispenser of claim 1, further including first circuit means responsive to a received signal for dispensing tokens.

4. The universal token collector and dispenser of claim 1 wherein said token collecting means include second circuit means for generating a signal in response to receipt of a token by said token collecting means and for transmitting said signal to a fulfillment apparatus for distributing a predetermined quantity of a commodity.

5. The universal token collector and dispenser of claim 1 wherein the commodity to be distributed is a golf ball.

6. In a system including revenue apparatus for receiving valuable consideration and fulfillment apparatus for delivering a desired commodity, a token acceptor and dispenser comprising:
a hopper for storing tokens each representing an increment of value for the purchase of the desired commodity;
token dispensing means connected to said hopper for delivering, in response to a signal from the revenue apparatus that consideration has been received for a predetermined number of tokens, the predetermined number of tokens; and
token receiving means connected to said hopper for delivering received tokens to said hopper, said token receiving means including signaling means for generating an enabling signal to the fulfillment apparatus to allow the delivery of the desired commodity,
whereby the token acceptor and dispenser apparatus is alternatively placed with revenue apparatus until said hopper is substantially depleted of tokens and with the fulfillment apparatus until said hopper is substantially full of tokens.

7. The apparatus of claim 6 above wherein golf balls are the desired commodity.

8. A token collector and dispenser comprising:
a hopper for storing tokens;
collector means including apparatus for accepting tokens and for transferring accepted tokens to said hopper;
enabling means connected to said collector means and operable in response to the receipt of a token for actuating a fulfillment device to deliver a predetermined quantity of a desired commodity;
dispensing means including an output mechanism in said hopper for dispensing a predetermined number of tokens in response to the receipt of value consideration from a revenue receiver;
whereby the token collector and dispenser can be used alternatively to dispense tokens from said hopper in a first operational mode and to receive tokens to control a fulfillment device in a second operational mode.

9. The token collector and dispenser of claim 8 above wherein said enabling means include signal generating means operable in response to the receipt of a token for generating and transmitting an enabling signal to actuate the fulfillment device.

10. The token collector and dispenser of claim 8, above, wherein the desired commodity is a golf ball.

11. A commodity dispensing system comprising in combination:
revenue collecting means for recording the receipt of collected revenue and for generating dispensing signals in response to the receipt of revenue;
token dispensing and collecting means adapted to be connected to said revenue collecting means and operable upon receipt of dispensing signals therefrom for dispensing tokens and including token receiving means for generating delivery signals in response to received tokens; and
fulfillment means for storing a quantity of a commodity to be delivered, said fulfillment means being adapted to be connected to said token dispensing and collecting means and operable in response to delivery signals therefrom to deliver a predetermined quantity of the stored commodity, whereby said token dispensing and collecting means are alternatively connected to said revenue collecting means and said fulfillment means, so that tokens collected when connected to said fulfillment means can be dispensed when connected to said revenue collecting means.

12. The commodity dispensing system of claim 11 whereby golf balls are the commodity dispensed.
